(19) United States
(12) Patent Application Publication
(10) Pub. No.: US 2015/0208716 A1
(43) Pub. Date: Jul. 30, 2015

(54) PRODUCTION OF FORMED FOODSTUFF

(71) Applicant: ALBERT HANDTMANN MASCHINENFABRIK GMBH & CO. KG, Biberach (DE)

(72) Inventor: Klaus Schmid, Riedlingen (DE)

(21) Appl. No.: 14/608,059

(22) Filed: Jan. 28, 2015

(30) Foreign Application Priority Data
Jan. 29, 2014 (EP) 14153080.8

(51) Int. Cl. A23P 1/10; B29C 45/00

(52) U.S. Cl. CPC A23P 1/105; B29C 45/0001

(57) ABSTRACT

Various systems and methods for the production of formed foodstuff are provided. In one example, a method for producing formed foodstuff comprises filling n-successively circulating molds with a foodstuff mass with a conveying device, wherein, during a first filling period the conveying device is controlled in a first filling mode such that a predetermined portion of a filling volume of a mold is filled, and subsequently, during a second filling period, a remaining portion of the filling volume of the mold is filled in a second filling mode in which the conveying device is controlled in response to a filling pressure such that a predetermined filling pressure is set in the mold.

### CROSS REFERENCE TO RELATED APPLICATIONS

The present application claims priority to European Patent Application No. 14153080.8, entitled “METHOD AND APPARATUS FOR PRODUCING FORMED FOODSTUFF,” filed on Jan. 29, 2014, the entire contents of which are hereby incorporated by reference for all purposes.

### FIELD

The disclosure relates generally to producing formed foodstuff.

### BACKGROUND AND SUMMARY

A variety of methods and apparatuses for producing formed foodstuff, such as chicken nuggets, formed schnitzel, pressed meat, shaped potato products, etc., are known. One example of such a known apparatus comprises a conveying device, e.g., a vane pump, which passes the foodstuff mass from a hopper into a supply pipe. From this supply pipe the foodstuff mass is filled into molds under constant pressure. The molds are e.g., arranged around the circumference of a drum, so that the molds can be filled one after the other. The filling of containers can here be subdivided into the following sequence steps: (1) recognition of the mold at the feed pipe, (2) filling the mold, and (3) closing the mold under a defined constant pressure. These steps may be cyclically repeated. Step 1, recognizing that the mold is located in the filling position, can e.g., be carried out via a position sensor or a pressure sensor during production.

During filling of the mold, displacement of the air in the mold may be desired; there are typically several options: the air can escape through small gaps, the air may be sucked off via a vacuum, the container is brought by filling with filling material to the final volume, e.g., a cylinder is filled having a piston which is pressed by the filling material onto end stop.

Filling may be carried out such that the conveying mechanism is controlled in response to the pressure in the mold and in the feed pipe or conveying mechanism outlet, respectively. To this end a corresponding sensor may be provided which compares an actual value with a target value. A corresponding pressure regulation can also be carried out via a pressure regulation cylinder. After the mold has been filled, the mold may be closed under the set constant pressure.

Finally, the shaped food products may be ejected from the mold in that e.g., a piston presses the mass mechanically out of the mold. The shaped food products can be ejected with compressed air out of molds which are provided with air channels or are made of air-permeable sinter material, for example.

The approaches described above may have several potential issues. For example, the filling speed may be set manually, and can be difficult and demanding of considerable expertise. A high filling speed can lead—due to the slow regulation—to high pressure peaks when the mold is full. At a filling speed that is too low, the container is not full, which can lead to portioning inaccuracies. Upon a change, e.g., rotational speed of the molds, a corresponding speed adjustment may be carried out again, resulting in the case of an incorrect adjustment in excessively high pressure peaks which will lead to waste and will damage the mold, in the worst case.

In some approaches, material is conveyed at a high conveying speed against the full or closed container. An exact filling can be difficult, particularly when the molds differ in their geometry and their volume from one another. Likewise, the chamber recognition via a position switch can be difficult in the case of different chamber shapes. Upon changeover to other shapes the position of a position switch may no longer be correct for detecting the filling position.

One approach that at least partially addresses the above issues includes a method for producing formed foodstuff comprising filling n-successively circulating molds with a foodstuff mass with a conveying device, wherein, during a first filling period the conveying device is controlled in a first filling mode such that a predetermined portion of a filling volume of a mold is filled, and subsequently, during a second filling period, a remaining portion of the filling volume of the mold is filled in a second filling mode in which the conveying device is controlled in response to a filling pressure such that a predetermined filling pressure is set in the mold.

In this way, reliable mold filling, particularly in scenarios in which different mold volumes are employed, may be provided.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure. Finally, the above explanation does not admit any of the information or problems were well known.

### BRIEF DESCRIPTION OF THE DRAWINGS

FIG. 1 shows a schematic section through an apparatus for producing formed foodstuff according to the present disclosure.

FIG. 2 shows a section through an apparatus according to the present disclosure in a perspective illustration.

FIG. 3 shows a section through a mold drum in a perspective illustration with molds of a different geometry.

FIG. 4 shows a top view on the outside surface of a mold drum according to the present disclosure and a list of the corresponding volumes and filling positions.

FIG. 5 is a rough schematic view showing a section through an apparatus according to a further embodiment of the present disclosure with a mold belt.

FIG. 6 shows the top view on the outside of the mold belt and a table which indicates the volumes of the molds in the individual rows and the positions.

FIGS. 7A, 7B, 7C are schematic representations which illustrate the detection of the chamber opening position.

FIGS. 8A, 8B, 8C are schematic representations which illustrate the detection of the mold closing position.

FIGS. 9A, 9B, 9C are schematic representations which illustrate the determination of the mold volumes.

FIGS. 10A, 10B, 10C are schematic representations which illustrate the production sequence for filling a mold.

FIG. 11 shows an apparatus according to a further embodiment according to the present disclosure.

FIG. 12 schematically shows an arrangement of molds according to an embodiment of the present disclosure.

### DETAILED DESCRIPTION

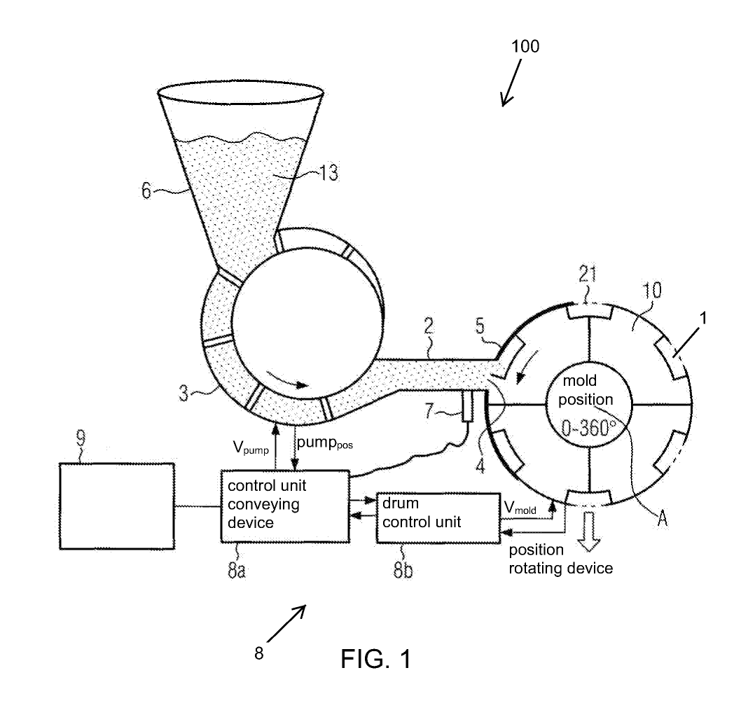

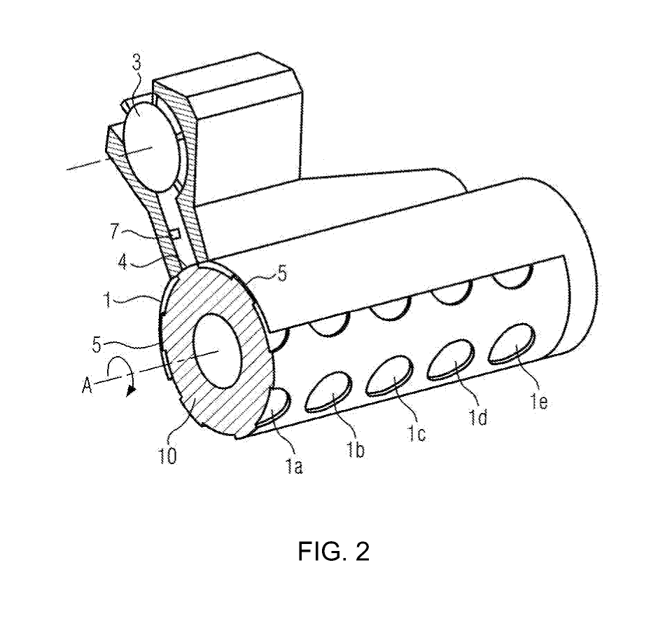

The present disclosure provides methods and apparatuses for producing formed foodstuff. FIG. 1 shows an apparatus 100 for producing formed foodstuff, such as chicken nuggets, formed schnitzel, pressed meat, shaped potato products, etc., in a schematic representation. Here, the apparatus 100 comprises a filling hopper 6 into which the foodstuff mass 13 can be filled. The hopper is followed by a conveying device 3, e.g., a conveying mechanism, e.g., in the form of a vane pump. Other pump forms are however also possible, e.g., a screw type feed pump or piston type conveying mechanism. The conveying device 3 is followed by the supply device 2, here in the form of a supply pipe. The supply device 2 comprises an outlet opening 4 through which the foodstuff mass 13 can be filled into molds 1. n-successively circulating molds 1, in FIG. 1 six circulating molds 1, are provided. The molds comprise in this case recesses in the surface of a rotating device, here the mold drum 10, and comprise an outwardly oriented open side 21, as becomes particularly also apparent from the perspective representation in FIG. 2. The molds 1 may also comprise a plurality of mold chambers 1a,b,c,d,e (FIG. 2) which are arranged in a row, the mold chambers of a row then forming the mold 1. The molds may comprise air channels or may be made of air-permeable sinter material, for example. The drum 10 is rotatably supported about an axis A and is rotated by a drive shaft at a speed V_{mold}, as illustrated by the arrow, during the filling process. The molds 1 are guided past the outlet opening 4 of the supply device in circulating fashion and are tightly closed before and after filling by way of a cover 5 which is connected to the supply device or the supply pipe 2, respectively. The cover 5 is concentrically arranged relative to the drum 10, the drum surface contacting the inside of the cover 5. This means that the molds which move past the outlet opening 4 of the supply device 2 along the path of circulation are first in the closed state, then open at a mold opening position towards the outlet opening 4, are filled through the opening 4, run past the outlet opening 4 and are closed again by the cover 5 at a mold closing position.

The apparatus 100 further comprises a pressure sensor 7 which is here arranged in the supply device, particularly the supply pipe 2. The pressure sensor 7, however, could also be arranged in the end portion of the conveying device 3. The filling pressure P_{fill} can be monitored via said pressure sensor 7. The apparatus further comprises a control device 8 which comprises a control unit 8b for the rotating device 10, particularly drum control unit, which controls the drum or the corresponding drive, respectively. Furthermore, the controller comprises a control unit 8a for the conveying device. The control unit 8a and 8b can also be integrated into a single controller. The control unit 8a sends e.g., signals to the drive of the conveying device 3 such that the speed Vₚᵤₘₚ of the conveying device can be controlled or regulated accordingly. The conveying device may be driven by a controlled servo motor, for example. Hence, said drive has a position detection and the control unit 8a continuously receives signals from the conveying device 3 about the motor position and thus also about the pump position. Furthermore, the control unit 8a is connected to the pressure sensor 7. Furthermore, the control unit 8a receives signals from the control unit 8b about the mold speed or the rotational speed of the rotating device 10, respectively. The controller 8b then controls the corresponding drive. On the other hand, the real position of the rotating device 10, here the drum with the molds 1, e.g., an angular position, is detected. This position is e.g., detected via a rotary encoder or position switch and then transmitted further to the control unit 8b and from there to the control unit 8a. It is however also possible that the rotating device 10 is moved by a motor controller in the control unit for the conveying device 8a. Finally, the apparatus 100 additionally comprises a display and input device 9. Each of the control units may include instructions stored in memory for, in cooperation with other hardware and/or system components, such as sensors and/or actuators, carrying out one or more of the methods described herein.

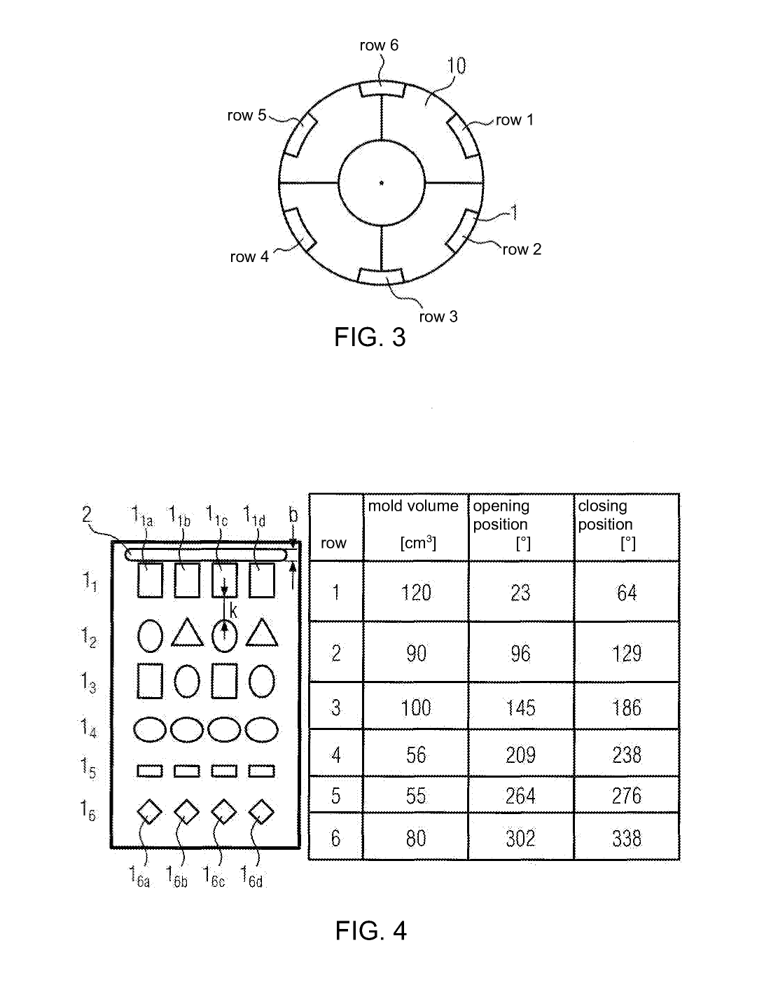

FIG. 3 shows a cross section through a mold drum in a perspective illustration, the mold drum comprising molds 1 of a different geometry or different cross-sections.

FIG. 4 shows a top view on the outside of the mold drum surface. In this embodiment the mold drum 10 comprises molds 1, wherein each mold 1, in turn, is comprised of a plurality of mold chambers 1₁ₐ, 1_{1b}, 1_{1c}, 1_{1d} to 1₆ₐ, 1_{6b}, 1_{6c}, 1_{6d}. This means that in this case each mold row comprises four individual mold chambers. The rows are arranged on the surface such that on the surface they have a specific filling position or a specific opening or closing position conforming to a specific rotary position of the rotating device or its drive. These opening and closing positions are stored in the controller. The mold volume, e.g., the volume of all individual mold chambers in a row, is stored for each row in the controller. The molds in the different rows can have a different geometry and a different volume. The individual mold chambers within a row can have different geometries and volumes, as follows particularly from row 2. It is here not ruled out that two closely successive sub-rows of mold chambers are combined in one row during filling, as follows particularly from FIG. 12. The mold chambers of the sub-rows are here interleaved. The mold chambers are simultaneously filled by the supply device.

The supply device, e.g., the supply pipe, has here a correspondingly large outlet opening 4 with a length greater than the length of a row, so that the supply device 2 can form a tight closure with the surface of the rotating device, here the drum 10. The width b of the outlet opening 4 is smaller than the distance k between two rows, so that pressure can build up between the rows in the supply device 2, which may be utilized, as shall be explained hereinafter, for detecting the opening and closing position and the chamber volume, respectively.

It will be appreciated that the configuration of mold drum 10 shown in FIG. 4 is provided as an example and is not intended to be limiting in any way. For example, one or more of the row and mold chamber number, row and mold chamber placement and relative positioning, row and mold chamber geometry, row and mold chamber size, etc. may be adjusted without departing from the scope of this disclosure. Further, the mold volumes, opening positions, and closing positions illustrated in FIG. 4 are provided as non-limiting examples and are not intended to be limiting in any way.

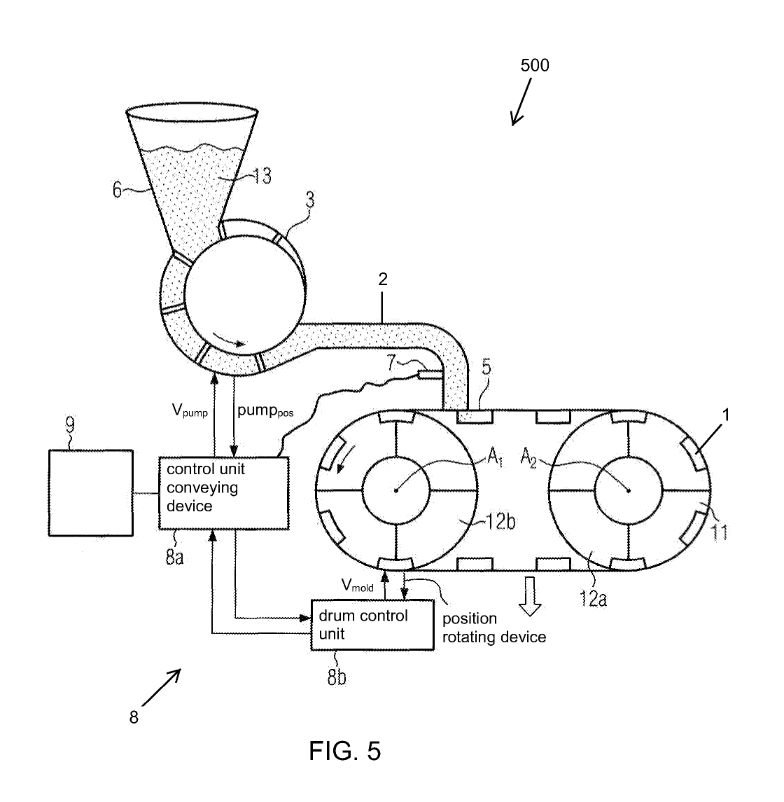

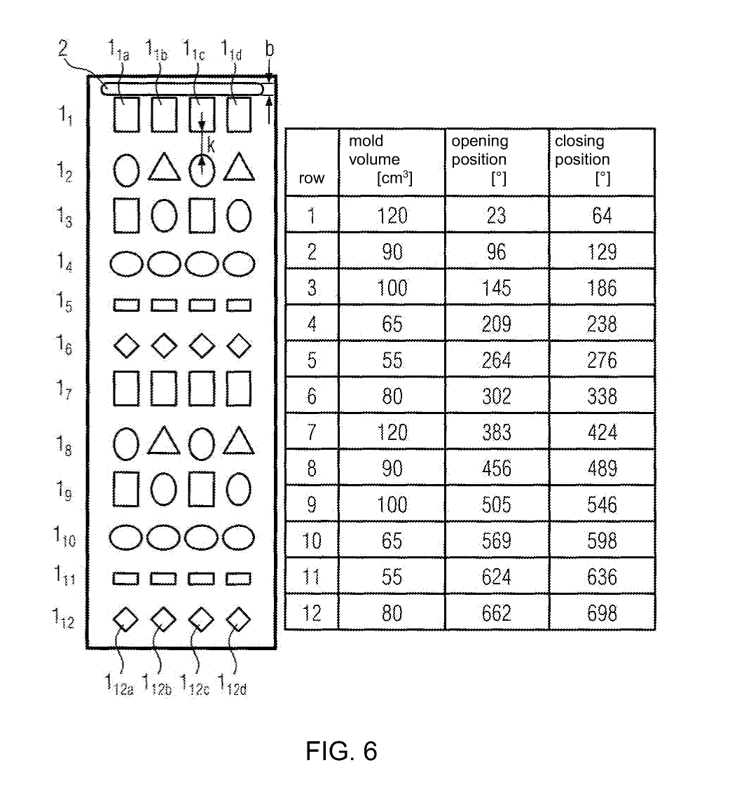

FIG. 5 shows an embodiment of an apparatus 500 according to the present disclosure. Apparatus 500 corresponds to apparatus 100 of FIG. 1, with the exception that, instead of a mold drum 10, a circulating mold belt 11 is provided as the rotating device, which is circulating around two axes A₁, A₂ or two rolls 12a, 12b, of which one is a drive roll. The mold belt 11 may e.g., have twice the length of the circumference of the drive roll. The molds 1 are formed in the surface of the mold belt 11. The mold belt may e.g., be made of plastics, such as a thermoplastic material. The molds may repeated after a predetermined angular position is traversed—e.g., the molds may be repeated after two revolutions of the drive roll (720°). As illustrated in FIG. 6, there are twelve molds on the whole, each comprising four mold chambers. The table of FIG. 6 also shows exemplary mold volumes of the individual rows and the opening and closing positions of the individual molds in the respective rows. It will be appreciated, however, that the configuration of mold belt 11 shown in FIG. 6 is provided as an example and is not intended to be limiting in any way. For example, one or more of the row and mold chamber number, row and mold chamber placement and relative positioning, row and mold chamber geometry, row and mold chamber size, etc. may be adjusted without departing from the scope of this disclosure. Further, the mold volumes, opening positions, and closing positions illustrated in FIG. 6 are provided as non-limiting examples and are not intended to be limiting in any way.

Knowledge of the mold volumes and opening and closing positions may be desired for the operation of apparatuses 100 and 500. These parameters may be determined before operating apparatuses 100 and 500, e.g., before the beginning of the filling process, and may be stored in a corresponding controller in a storage device (e.g., in control device 8).

Such parameters may be determined via calculation and measurement. It may be desired, however, that these parameters be recorded in a learning mode prior to the filling process; e.g., an adaptively learning system may be used. This means that rotating devices, e.g., mold belts or drums, may be variable and exchangeable in any desired manner, and the system itself newly adapts the process in a corresponding manner.

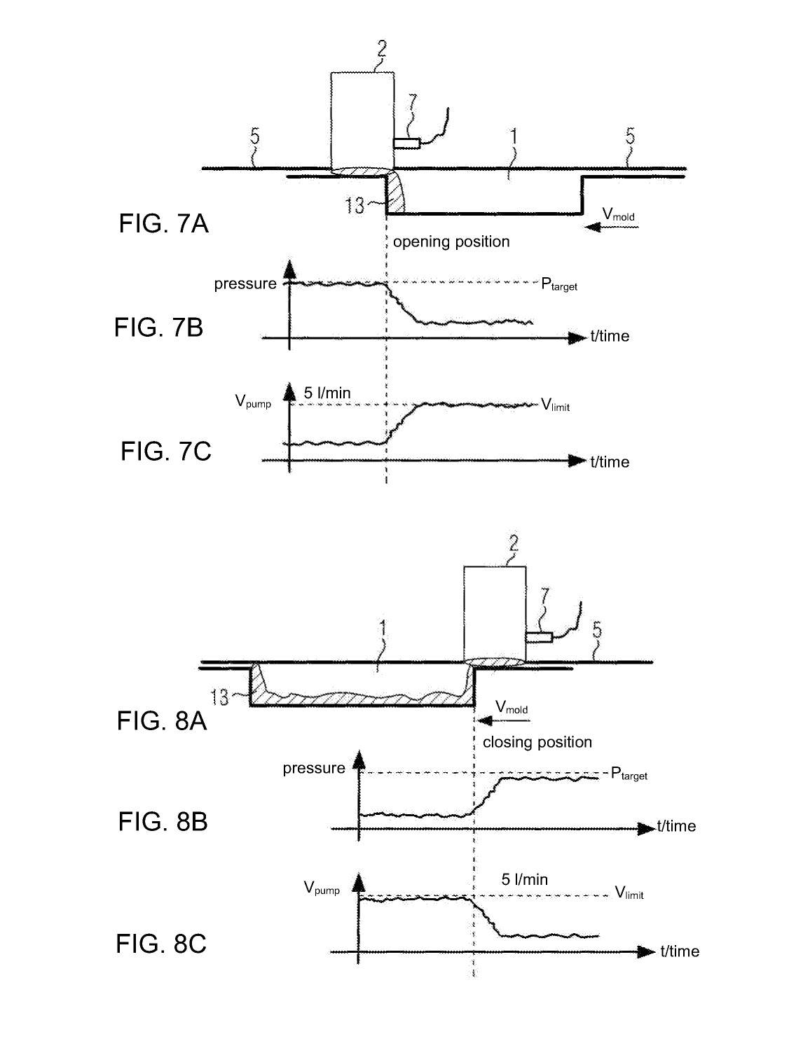

It is illustrated in FIGS. 7A-7C how the opening position of a mold or a mold row can be determined. FIG. 7A shows a longitudinal section through a portion of the apparatus. For the detection of the opening position the conveying device 3 (FIGS. 1 and 5) is operated in the pressure regulation mode, e.g., the filling pressure in the supply device 2 is regulated to have a specific target value P_{target}. The actual value of the filling pressure which is detected through the sensor 7 is compared with the target value, and the conveying device 3 is controlled accordingly such that a specific capacity or speed Vₚᵤₘₚ is obtained. A specific limit speed of e.g., 5 1/min is here set, though various suitable values may be used. As follows from FIG. 7A, the mold 1, e.g., mold 1 in row 1, as shown in FIGS. 1-6, moves in the direction of arrow V_{mold} under supply device 2 or under cover 5, respectively. Prior to filling, the opening 21 (FIG. 1) of the mold 1 is closed by the cover 5. As soon as the mold 1 moves into the opening position, the outlet opening 4 and the opening 21 of the mold 1 are overlapping, and foodstuff mass 13 can enter into the mold 1, which leads to a pressure drop in the supply device 2, as illustrated in FIG. 7B. Before the mold 1 enters into the opening position, the outlet opening 4 (FIG. 1) is sealed by the surface, e.g., of the drum or the mold belt, such that the target pressure can build up. At the beginning of the pressure drop the opening position is fixed. A pressure drop is e.g., recognized whenever the pressure drops below a specific threshold value, e.g., at least 0.2 bar to 1.5 bar of the set target value P_{target}, though various suitable values may be employed. At the same time, since the actual value of the filling pressure differs from the target value of the filling pressure P_{target}, the conveying capacity, e.g., here the conveying speed, is raised to a limit speed, e.g., in a range of 1 to 10 1/min, and as a particular non-limiting example, 5 1/min.

When the opening position is detected, a corresponding position of the rotating device 10, e.g., angular position (e.g., degree) of the corresponding drive, is detected and stored (e.g., as shown in FIGS. 4 and 6).

FIGS. 8A, 8B, 8C illustrate a method for detecting the mold closing position. After having passed the opening position (FIG. 7A), the mold 1 is moved on in the direction of arrow V_{mold} and is filled via the supply device 2. In this case, too, the conveying device is operated in the pressure regulation mode and regulates the pressure in the supply device 2 to a specific target pressure P_{target} e.g., to 1 bar, as has been described above. The capacity of the conveying device is relatively low, e.g., a limit speed of the conveying device 3 is set to be low so that the mold is not full in the learning mode. Pressure compensation can take place between the individual chambers of the respective mold of the row. A corresponding speed of the conveying device can be estimated in response to the speed of the mold V_{mold} and to the estimated or known volume of the mold opening. As follows from FIG. 8B, the actual value for the pressure during filling is thus clearly below the target value P_{target}, e.g., at 0.5 bar, and the conveying device 3 is therefore operated at the maximally adjusted limit speed Vₗᵢₘᵢₜ. The beginning of a pressure rise beyond a specific threshold value, in this example to 1 bar, signals the closing of the chamber. This detected closing position can again be assigned, as has been described above, to a specific position of the drive, e.g., to a specific angular position (e.g., degree), and stored. The method shown in connection with FIGS. 7 and 8 may be repeated until all mold positions on the circumference of the drum 10 or the mold belt 11 and the circulating device, respectively, which comprises the molds 1, are known. Due to the cyclically recurring mold positions all opening and closing positions of the subsequent n-molds or mold rows may be known.

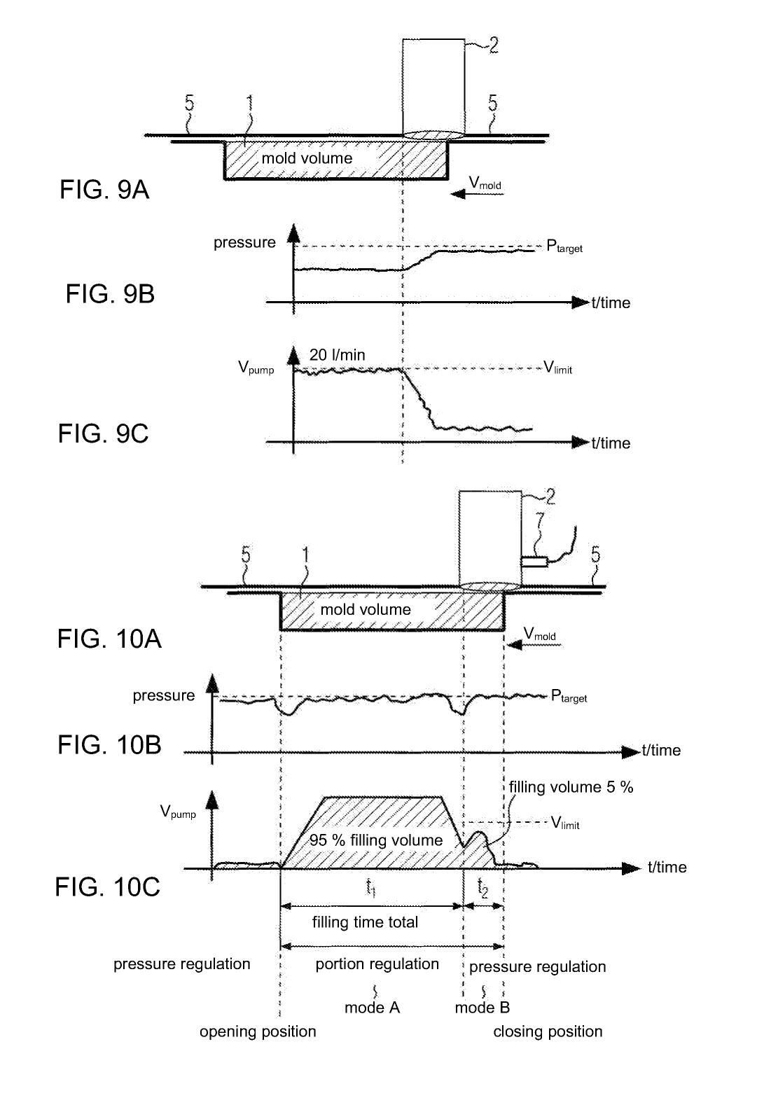

In connection with FIGS. 9A, B, C, it shall be explained in more detail how the chamber volumes of the individual molds are determined. The chamber volume can be determined after determination of the opening and closing positions. The conveying device is again operated in the pressure regulation mode at a specific target value P_{target}, e.g., 1 bar. Here, however, a higher filling rate may be chosen relative to that chosen in the method for determining the opening and closing positions. The filling rate may be selected so that the mold 1, which is moving at the speed V_{mold}, is already completely filled before the mold is again closed by way of the cover 5. The filling rate is here e.g., 20 1/min, though various suitable values may be employed. This speed is entered as a limit speed Vₗᵢₘᵢₜ. When the mold is full, the filling pressure P_{fill} also rises, as follows particularly from FIG. 9B, namely up to the limit value P_{target}, whereupon the conveying device 3 stops. The rise in pressure is due to a full chamber and not due to the closing of the chamber. It is assumed that at the beginning of the pressure rise the chamber is full. A rise in pressure will then be detected when the pressure rises to a specific threshold value e.g., by more than 0.5 bar. It is determined which volume has been ejected by the conveying device 3 during the period starting with the mold opening position up to the pressure rise. This volume can be determined easily because both the corresponding time and the conveying speed or capacity, respectively, is known. The conveying volume may be stored for the corresponding chambers in the controller, as described above with reference to FIGS. 4 and 6. Molds with different volumes can thereby be detected with ease.

As follows from FIG. 9C, the pump capacity or pump speed may be reduced in conformity with the pressure regulation as soon as the pressure rises.

As a result of the learning mode, as shown in FIGS. 7 to 9, both the opening position and the closing position and the corresponding volumes may be known for the molds in the n-rows, e.g., for rows 1 through 6 for apparatus 100 (FIG. 1) and for rows 1 through 12 for apparatus 500 (FIG. 5).

The portioning profile may then be calculated for each mold. The rotational speed of the rotating device V_{mold} is set to a production rate, e.g., 10 revolutions/min. Since the volume and the opening and closing position are known for each mold, the controller 8 (FIGS. 1 and 5) can calculate an optimum portioning profile. First of all, the total filling time from the opening time to the closing time is calculated. One exemplary relation for calculating the total filling time is as follows: Filling time total [s]=closing position—opening position/V_{mold}.

The difference between the closing position and the opening position corresponds to the distance covered by the mold between the positions, e.g., the inner length of the mold plus length of the supply opening 4. The closing and opening positions may be in units of degrees, while V_{mold} may be in units of degrees per second, for example.

According to the present disclosure the portioning process is subdivided into two sections, namely period t₁ and period t₂. Period t₁ may be greater than the period t₂ and about 70-98% of the total filling time tₜₒₜₐₗ, for example. During this first period t₁, a major part of the foodstuff mass is filled, for example 70-98%, or as one particular non-limiting example 95%. The portion time t₁ may be calculated as Portion time t₁=tₜₒₜₐₗ×90%, while the portion volume may be calculated as Portion volume=specific filling volume×95%, though these specific percentages are provided as non-limiting examples and may be adjusted without departing from the scope of this disclosure.

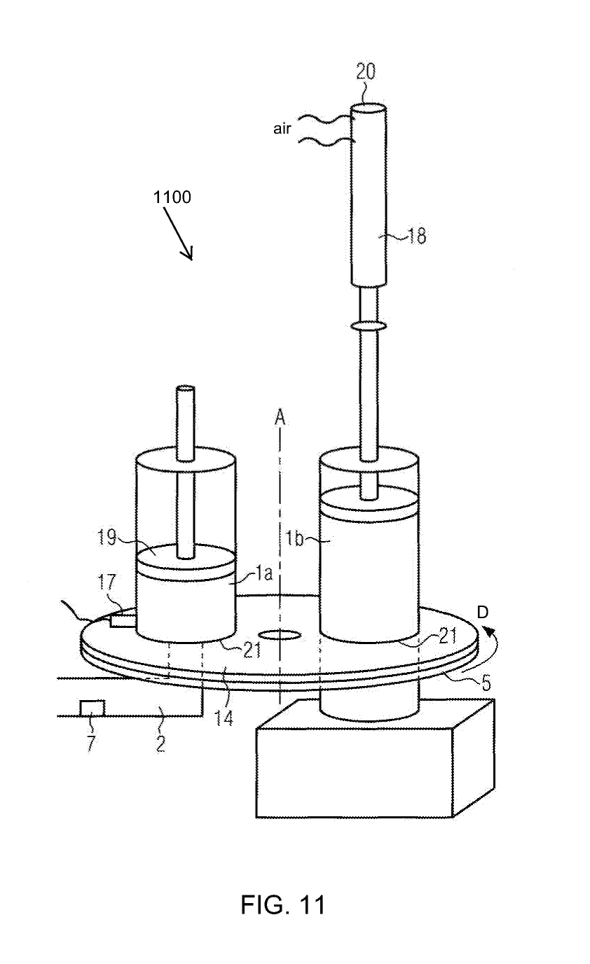

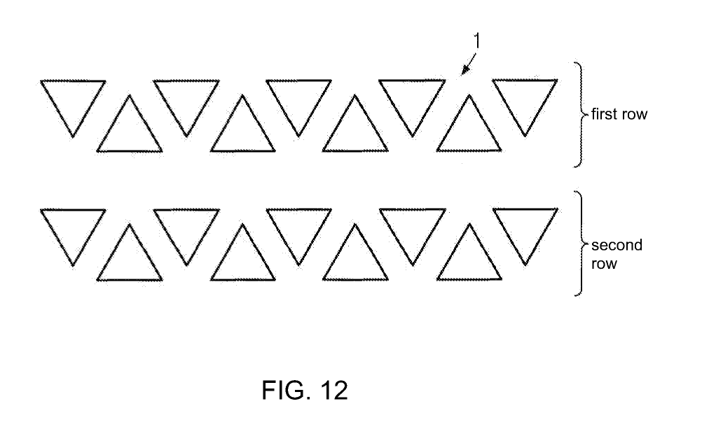

During the filling period t₁, the conveying device 3 is controlled in a first mode A such that the predetermined portion, e.g., 95%, of the filling volume of the respective mold is filled. The conveying device 3 can here be driven with a relatively high power. The conveying device is switched off in case of overpressure at e.g., 5-10 bar, e.g., in the event that the chamber has not been emptied. The speed Vₚᵤₘₚ of the conveying device follows from the profile calculation of portion volume and portion time t₁. Before the mold 1 runs into the opening position, a pressure regulation is carried out, the pressure being set to a pressure P_{target}, e.g., 1 bar. Since the distance between individual rows k (FIG. 4) is, as has been described above, greater than the width of the outlet opening 4, the pressure P_{target} can, as P illustrated in FIG. 10, build up before the opening position. The capacity of the conveying device or its speed is therefore reduced in a controlled manner and thus may be small or in some examples 0. The control device 8 continuously receives signals indicating in which position the rotating device, e.g., the drive of the molds 1, is located, e.g., in which angular range. These signals are e.g., recorded by way of a rotary encoder or a position switch. Now, if the control device determines that the current position e.g., of the drive or the drum 10, respectively, or of the mold belt 11 or a turntable 14 (FIG. 11) corresponds to an opening position of a specific mold, the controller switches from pressure regulation to portion regulation and increases the filling capacity, e.g., the filling speed Vₚᵤₘₚ, to a value which is greater than the conveying capacity or the conveying speed Vₗᵢₘᵢₜ in the control regulation mode and follows from the profile calculation of portion volume and portion time t₁. Hence, a portion (e.g., 95%) of the filling volume is filled in the first filling period t₁. At the end of the filling period t₁, the conveying device capacity or the speed Vₚᵤₘₚ is lowered, here to a value below the limit speed Vₗᵢₘᵢₜ. Now, the mode A, e.g., the portion regulation, is terminated and the controller switches back to pressure regulation, where a specific target value P_{target} is here also set again, said target value P_{target} corresponding to the filling pressure which is to be exerted on the mold at the end of the filling operation. This pressure regulation corresponding to mode B takes place during the second filling period t₂, with the remainder of the volume being filled (e.g., the remaining 5%, if 95% was filled in the first filling period t₁). If the target pressure P_{target} is reached, the capacity of the conveying device or the speed Vₚᵤₘₚ is reduced or the pump is stopped, respectively, as follows from FIG. 10, the pressure being here kept at P_{target} during the filling period t₂. It may be desired that before the complete reclosing of the mold said mold is fully filled with the whole, previously determined filling volume and acted upon with the set pressure P_{target}. The volume that is filled in follows from the volume of the chamber filled at constant pressure. Hence, a very high portioning accuracy is possible without the occurrence of pressure peaks or damage to the container. The successively arranged circulating molds or mold rows are thereby filled. As becomes clear from the preceding description, the learning mode considerably simplifies the adjustment of apparatuses 100 and 500 of FIGS. 1 and 5, respectively. Incorrect adjustments can be mitigated or obviated. Changes in the speed of the molds or the rotating device (drum speed, mold belt speed) may not demand any manual adaptation. The position detection by means of pressure sensor also works with different mold shapes within a drum or within a mold belt.

FIG. 11 shows an embodiment of an apparatus 1100 according to the present disclosure. This apparatus 1100 comprises a conveying device 3 (not shown) with a supply device 2 and corresponding controller, which conform to the corresponding elements, as described in connection with the preceding embodiments. Instead of the rotating drum or the circulating mold belt 11 a rotary table 14 is here provided as the rotating device, the table rotating about the axis A in a direction indicated by arrow D with the help of a corresponding drive. Molds 1 having a downwardly exposed opening are arranged on the table. The turntable 14 comprises a corresponding cutout. Corresponding portioning pistons 19 which are movable upwards and downwards in the cylinder are provided in the molds 1. Furthermore, a position switch 17 is provided that detects the position of the turntable 14. Here, there are also n-successively circulating molds 1. There are two molds in the embodiment illustrated in FIG. 11, though various suitable mold numbers are possible without departing from the scope of this disclosure. Like in the preceding embodiments, the supply device has connected thereto a cover 5 which is here also configured as a disk and comprises a recess in the area of the inlet opening 4 (FIG. 1) of the supply device, and moreover an ejection opening through which the product can be ejected out of the cylinder.

An exemplary process for operating apparatus 1100 takes place as follows. The turntable 14 is rotated via a drive (e.g., pneumatically or electrically) into the filling position in which the outlet opening 4 is opposite to the supply device 2 of the opening 21 of the mold 1. The position switch 17 detects the position of the rotating device, here the table. Subsequently, the mold 1 is filled via the supply device 2 during a first filling period t₁, the conveying device 3 being controlled such that a predetermined portion of the filling volume of the corresponding mold is filled (filling mode A) without a pressure regulation being carried out. Subsequently, during a second filling period t₂ the mold 1 is filled with the remaining share of the filling volume of the corresponding mold in a second filling mode B, in which the conveying device 3 is controlled in response to the filling pressure P_{fill}, in such a manner that a predetermined filling pressure is obtained in the mold 1, as has been described in connection with the preceding embodiments and as shown in FIG. 10C. The portioning piston is pressed upwards by the inflowing filling material mass. At the same time a further mold 1 is located in the ejection position, and simultaneously with the filling operation an ejection cylinder 18 ejects the filling material via the portioning piston, e.g., into a mold of a thermomolding packaging system. By comparison with the preceding embodiments, the turntable is stopped during the filling operation when the openings 1 and 4 are opposite each other.

When a cylinder is full and acted upon with the preset pressure P_{target}, the cylinder is closed by rotating the turntable 14 in the direction of rotation by way of the cover 5, and at the same time the second mold 1b is moved away out of the ejection position and a new filling cycle starts. It may be desired that the filling material is cut off during rotation of the turntable under pressure, e.g., 1 bar. The result thereof is a high portioning accuracy. The molds 1a,b to be filled can of course also be arranged in other formations (e.g., radially in a row). In this embodiment the filling positions of the n-molds 1 on the circulation path can also be determined, particularly the respective opening and closing position of the corresponding mold, and the filling volume of the mold, as has been explained previously. As has been described above, corresponding values can be stored. It is also possible to carry out a corresponding learning mode prior to the filling operation proper, as has been explained above, and to assign specific angles to the individual molds for the filling position, but particularly the opening and closing position, so that the controller recognizes that a specific mold 1 is in the filling position when the position switch 17 determines that the turntable 14 is located in a corresponding angular range or at a corresponding position. Filling can be carried out according to the sequence shown in FIG. 10C, for example. The conveying device 3 is here controlled in the same way as has been explained in detail with respect to the previous embodiments in connection with FIG. 10. In contrast to the preceding embodiment, however, the rotating cylinder may remain positioned in the ejection position for a predetermined period of time until the foodstuff mass has been ejected completely into the ejection portion in the mold 1b. The mold then moves together with the turntable further up to a closing position in which the outlet opening 4 and the opening 21 of the mold are no longer overlapping and the mold 1 is closed from below. When the total filling time is determined, the time during which the mold 1 stands still is added to the filling time as determined in the preceding embodiments. Hence, an anticipatory adjustment of the portioning profile is equally possible in this embodiment.

The approaches described herein for producing formed foodstuff may enable reliable filling, particularly in the case of different mold volumes.

In one example, the conveying device is controlled in a first filling mode during a first filling period t₁ such that a predetermined portion of the filling volume of the respective mold is filled and subsequently, during a second filling period t₂, the remaining portion of the filling volume of the respective mold is filled in a second filling mode in that the conveying device is controlled in response to the filling pressure p_{fill}, such that a predetermined filling pressure is set in the mold.

In contrast to other approaches, the filling time tₜₒₜₐₗ is comprised of two filling periods t₁ and t₂, wherein in the first filling period a main portion of the filling volume is filled into the respective mold. Hence, it is possible to carry out an optimized volume filling in a first mode, wherein the foodstuff mass is introduced via the conveying device with a high capacity without pressure regulation. Since a predetermined portion is now introduced in mode A, a situation can be avoided where shortly before the filling end, material is conveyed at a high filling speed against the full mold. High pressure peaks, which may destroy the foodstuff or, in some examples the mold, may be mitigated or obviated. In the second filling period t₂ the remaining portion which is smaller than the main portion of the filling volume can then be filled, with a pressure regulation being here carried out, e.g., the conveying device is controlled in response to the filling pressure such that a predetermined filling pressure is set in the mold, namely before the container is subsequently reclosed, which leads to a high portion accuracy.

In some examples, the first filling period t₁ is greater than the second filling period t₂ and the mean conveying capacity of the conveying device 3 during the first filling period t₁ is greater than during the second filling period t₂. This means that the main portion with the high conveying capacity is filled during the first period and the conveying capacity can be reduced in the second period. Hence, since the filling speed is reduced in the second filling period t₂, the filling pressure can be regulated to a predetermined value—in the absence of pressure peaks. The capacity of the conveying device may be reduced at the end of the first filling period. The “end of the first filling period” as used herein may refer to the capacity or the speed of the conveying device starting to decrease in the last third of this period.

In some examples, in the second filling mode a target value is e.g., predetermined for the filling pressure, and the conveying device is driven until the actual value of the filling pressure corresponds to the target value. The filling pressure sensor may e.g., be provided in the outlet region of the conveying device or in a supply device, particularly a feed pipe, which is connected to the conveying device. The regulation device may maintain the target value for the filling pressure. It is also possible to provide a pressure compensation vessel in the form of a spring-loaded pressure compensating cylinder, e.g., a pressure regulation cylinder, in a supply device. An additional dead volume is thereby obtained. When the mold is completely filled, the pressure in the supply device will also rise, whereby the spring-loaded piston of the pressure regulation cylinder is moved, which can be recognized by a position sensor. With the position sensor, the conveying device is then stopped. When the pressure decreases thereupon, the piston will again move inwards such that a specific volume is displaced and a specific pressure can be maintained until the mold is completely closed. The pressure prevailing in the mold is thus set by the spring preload of the pressure regulation cylinder. The conveying device can e.g., be started again in that the position switch is released again or a second position switch recognizes that the set pressure is no longer achieved. Such functionality may be implemented in apparatus 1100 of FIG. 11, for example.

Owing to the exact pressure regulation it is possible to achieve not only a precise complete filling of the molds, but also a substantially uniform (e.g., less than 1% variation) compression of the foodstuff mass.

According to an embodiment of the present disclosure, the molds are guided with their opening past an outlet opening of the supply device for the foodstuff mass and before and after filling they are tightly closed by way of a cover which is especially connected to the supply device. This means that the molds which move along the path of circulation past the outlet opening of the supply device are first in a closed state, then open at a mold opening position towards the outlet opening, are filled, run past the outlet opening and are again closed at a mold closing position.

In some implementations, when before the beginning of the filling process, e.g., before the production of the formed foodstuff starts, the respective filling position of the n-molds is determined on the path of circulation, particularly the respective mold opening position and the mold closing position and the filling volume of the molds. This means that e.g., the filling position and the mold opening and mold closing position, respectively, of each mold can then be assigned to a corresponding position or angular position of a rotating device, e.g., rotating drum, with which the molds are rotating, especially to a position or angular position of a drive of the rotating device, e.g., a rotary shaft. During operation the current position of the rotating device or the drive, respectively, can then be determined for the molds e.g., via a rotary encoder or a position switch, so that it can then be determined during production when a mold is in the filling position or when the mold opening position or the mold closing position is reached. Since before the process the corresponding positions and filling volumes for each individual mold are known, the portions of the filling volume that are filled during the first and second filling periods, as well as the durations of the filling periods and the corresponding conveying capacities can be set exactly in an anticipatory manner. The corresponding data may then be stored in a controller.

In some examples, when for the determination of the filling position of the n-molds and/or for the determination of the filling volume of the n-molds the apparatuses described herein are operated in a learning mode prior to the foodstuff mass filling process proper, and the respective filling positions (mold opening positions and mold closing positions) and filling volumes for the individual molds are stored in a controller. The individual process parameters are then calculated accordingly by the controller. It may be desired that, when prior to the production, a corresponding learning mode is carried out because an optimal filling profile can be calculated by detecting the position and the volume of the molds to be filled, which also simplifies the setting of the machine. Even in case of a change in the mold speed (or the rotating device, respectively) no manual adaptation is needed. The method also works in the case of different chamber shapes within a rotating device, e.g., drum or a drum belt circulating about at least two axes, or a turntable.

For the adaptive determination of the mold opening position the conveying device can be controlled such that a constant target value is set for the filling pressure, the mold opening position being detected at the beginning of a pressure drop in the filling pressure. This means that when the open side of the mold begins to overlap with the outlet opening, a pressure drop takes place, which can be clearly assigned to the mold opening position of said corresponding mold. The corresponding position of the rotating device can then be stored in the controller. The mold closing position can then be detected when the measured filling pressure starts to rise again. Hence, the corresponding positions can be determined in a simple manner, namely independently of the speed of the circulating molds and independently of the mold size and geometry.

For determining the volume of the n-molds the respective molds are filled, and it is detected that the mold is full when a pressure rise in the filling pressure sets in, and it is determined which volume has been ejected by the conveying device during the period of time from the mold opening position up to the pressure rise. The conveying capacity of the filling device may be set to be sufficiently high that the rise in pressure is carried out by the filled-in foodstuff, and not by the closing of the mold e.g., by the cover. The volume to be conveyed depends on the air content of the filling material. With a high air portion more volume may be conveyed to produce the desired pressure towards the end of the filling phase than in the case of a smaller air portion. Since the volume is determined in a learning mode and is not just calculated, the inclusion of the air portion in the dead volume between conveying mechanism and chamber to be filled can be compensated. Possibly arising leakage in the conveying mechanism or the mold drum is compensated.

Before the beginning of the filling process e.g., before the production proper, the rotational speed of the n-molds may also be determined, the total filling time being calculated from the mold opening position, the mold closing position and the rotational speed for each mold, and the duration of the first filling period t₁ and of the second filling period t₂ as well as the portion of the filling volume during the first filling period t₁ and the portion of the filling volume during the second filling period t₂ are determined, for example.

As non-limiting examples, the filling period t₁ is 70-98%, particularly 85-86% of the total filling time (t₁+t₂). Further, 70-98%, particularly 90-96%, of the filling volume is filled during the first filling period. It will be appreciated, however, that these ranges are provided as examples and are not intended to be limiting in any way. Various suitable ranges may be employed without departing from the scope of this disclosure.

In some examples, the whole filling volume which has been determined for a corresponding mold is filled into the mold and acted upon with the set pressure before the mold is again arranged in the mold closing position. This permits a precise portioning.

In some examples, a mold may comprise a plurality of mold chambers 1a,b,c,d (FIG. 2), potentially in addition to others (e.g., 1e) arranged next to one another in a row. These mold chambers may also have a different geometry, e.g., also different volumes. The mold chambers may be arranged in their orientation also differently or a mold may also comprise two sub-rows that are closely adjoining one another or are interleaved with one another and represent a mold and are filled jointly and simultaneously by a supply device via its outlet opening. During filling the supply device forms a tight closure with an area around said mold, with pressure compensation between the individual mold chambers.

In some examples, the width of the supply opening (width viewed in the direction of movement of the molds) is smaller than the distance between two molds or mold rows in circumferential direction. This makes it possible that the parameters, such as mold opening position, mold closing position and filling volume, can be determined in a sufficiently accurate manner, because the pressure can be built up in the supply device, e.g., the supply line, so that a subsequent container will not open before the preceding container is entirely closed. Otherwise, a pressurized filling of the containers may not be feasible. This arrangement, however, permits high weight accuracy.

In some examples, a respective filling position on a path of circulation may be determined for each mold prior to filling the molds (e.g., molds 1 of mold drum 10 of FIG. 1). Determination of the respective filling positions may include determining, for each mold, a respective mold opening position and a respective mold closing position, and further a respective filling volume for each mold. Moreover, prior to filling the molds, a respective rotational speed may be determined for each mold. A total filling time may then be calculated from the respective mold opening positions, the respective mold closing positions, and the respective rotational speeds.

In some examples, before a mold is disposed in a mold closing position, a total filling volume has been filled in and the mold is subjected to a target value for a filling pressure.

In some examples, a first filling period may occupy a range (e.g., portion) of a total filling time, and a second filling period, which may be different from the first filling period, may occupy a remaining range (e.g., remaining portion) of the total filling time. As non-limiting examples, the first filling period may be within one of a first range from 70% to 98% of the total filling time and a second range from 85% to 95% of the total filling time. In some examples, during the first filling period one of a first range and a second range of the filling volume is filled, the first range being from 70% to 98%, the second range being from 90% to 96%, for example, though other suitable ranges may be used.

In some examples, a system for producing formed foodstuff comprises a rotary device comprising a plurality of molds. For example, the rotary device may be mold drum 10 of FIG. 1, or mold belt 11 of FIG. 5 circulating around two rolls. The plurality of molds may be molds 1 of FIG. 1, and may comprise various suitable numbers of molds. The system may further comprise a conveying device (e.g., conveying device 3 of FIG. 1) operatively coupled to the rotary device, the conveying device operable to feed foodstuff mass (e.g., mass 13 of FIG. 1) to the rotary device via a supply device such as supply device 2 of FIG. 1. The system may further comprise a first control unit (e.g., control unit 8b of FIG. 1) operatively coupled to the rotary device, and a second control unit (e.g., control unit 8a of FIG. 1) operatively coupled to the conveying device. The second control unit may be configured to control the conveying device in a first filling mode such that a predetermined portion of a filling volume of each mold is filled, the second control unit further configured to control the conveying device in a second filling mode such that a remaining portion of the filling volume is filled, the conveying device controlled responsive to a filling pressure such that a predetermined filling pressure is set in each mold in the second filling mode. The filling pressure may be measured via a pressure sensor such as pressure sensor 7 of FIG. 1. The first control unit may be configured to guide the plurality of molds past an outlet opening (e.g., opening 4 of FIG. 1) of the supply device, the plurality of molds being closed by a cover (e.g., cover 5 of FIG. 1) before and after filling. The first and second control units may be configured to determine, for each of the plurality of molds, a respective angular mold opening position on the rotary device and a respective angular mold closing position on the rotary device. These values may be stored in one or both of the first and second control units and used to facilitate the approaches described herein. The second control unit may be further configured to, in the first filling mode, drive the conveying device such that a first portion of a mold is filled in a first filling period, and in the second filling mode, drive the conveying device such that a second portion of the mold is filled in a second filling period, the first filling period being greater than the second filling period.

In some examples, a method of producing formed foodstuff comprises for each of a plurality of molds (FIG. 1) on a rotary device (FIGS. 1, 5), determining an angular filling position of that mold on the rotary device, determining a filling volume of that mold, filling a predetermined portion of the filling volume of that mold via a conveying device (FIGS. 1, 5) at the angular position for a first filling period, and filling a remaining portion of the filling volume of that mold via the conveying device at the angular position for a second filling period, the second filling period being less than the first filling period.

In some examples, determining the angular filling position includes determining a mold opening position based on a beginning of a pressure drop, and determining a mold closing position based on a beginning of a pressure rise. Changes in the pressure may be monitored via pressure sensor 7 (FIG. 1), for example.

In some examples, during the first filling period, the conveying device is operated in a portion regulation mode, and, during the second filling period, the conveying device is operated in a pressure regulation mode.

In some examples, the conveying device is operatively coupled to the rotary device via a supply device (FIG. 1).

In some examples, the rotary device is one of a mold drum (FIG. 1) and a mold belt (FIG. 5) comprising at least one drive roll.

It will be appreciated that the configurations and routines disclosed herein are exemplary in nature, and that these specific embodiments are not to be considered in a limiting sense, because numerous variations are possible. For example, variation in the implementations described herein, including but not limited to variations in geometry, dimensioning, relative positioning, quantity, etc., are possible without departing from the scope of this disclosure. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for producing formed foodstuff, comprising:
filling n-successively circulating molds with a foodstuff mass with a conveying device,
wherein, during a first filling period the conveying device is controlled in a first filling mode such that a predetermined portion of a filling volume of a mold is filled, and subsequently, during a second filling period, a remaining portion of the filling volume of the mold is filled in a second filling mode in which the conveying device is controlled in response to a filling pressure such that a predetermined filling pressure is set in the mold.

2. The method of claim 1, wherein the first filling period is greater than the second filling period, and
wherein a mean conveying capacity of the conveying device during the first filling period is greater than a mean conveying capacity of the conveying device during the second filling period,
the method further comprising, reducing a capacity of the conveying device at an end of the first filling period.

3. The method of claim 1, wherein in the second filling mode a target value is predetermined for the filling pressure, the method further comprising driving the conveying device such that an actual value of the filling pressure corresponds to the target value.

4. The method of claim 1, wherein the molds are guided past an outlet opening of a supply device for the foodstuff mass and are tightly closed by a cover before and after filling.

5. The method of claim 1, further comprising:
prior to filling the molds, determining, for each mold, a respective filling position on a path of circulation;
determining, for each mold, a respective filling volume; and
assigning, for each mold, the respective filling position to a position of a rotating device with which the molds are rotated.

6. The method of claim 5, wherein determining, for each mold, the respective filling position includes determining a respective mold opening position and a respective mold closing position.

7. The method of claim 6, wherein determining the respective mold opening positions includes controlling the conveying device such that a constant target value is set for the filling pressure,
wherein the respective mold opening positions are detected at a beginning of a pressure drop of the filling pressure, and
wherein the respective mold closing positions are detected when the filling pressure begins to rise.

8. The method of claim 6, further comprising:
prior to filling the molds, determining, for the molds, a rotational speed;
calculating a total filling time from the respective mold opening positions, the respective mold closing positions, and the respective rotational speeds; and
determining a duration of the first filling period, a duration of the second filling period, a portion of the filling volume during the first filling period, and a portion of the filling volume during the second filling period.

9. The method of claim 6, wherein it is detected that a mold is full when a pressure rise of the filling pressure begins, the method further comprising determining which volume was ejected by the conveying device during a time from the mold opening position up to the pressure rise to determine the volume of the n-molds.

10. The method of claim 5, wherein the respective filling positions and the respective filling volumes are determined in a learning mode, the method further comprising storing the respective filling positions and the respective filling volumes in a controller.

11. The method of claim 1, wherein the first filling period is within one of a first range from 70% to 98% of a total filling time and a second range from 85% to 95% of the total filling time.

12. The method of claim 1, wherein during the first filling period one of a first range and a second range of the filling volume is filled, the first range being from 70% to 98%, the second range being from 90% to 96%.

13. The method of claim 1, wherein before a mold is disposed in a mold closing position, a total filling volume has been filled in and the mold is subjected to a target value for a filling pressure.

14. The method of claim 1, wherein each mold comprises a plurality of mold chambers arranged next to one another in a row.

15. An apparatus for producing formed foodstuff, comprising:
a conveying device for conveying foodstuff mass;
n-successively circulating molds; and
a controller configured to, during a first filling period, control the conveying device in a first filling mode such that a predetermined portion of a filling volume of a mold is filled, and subsequently, during a second filling period, control the conveying device in response to a filling pressure such that a predetermined filling pressure is set in the mold, a remaining portion of the filling volume being filled in a second filling mode.

16. The apparatus of claim 15, wherein a width of a supply opening is smaller than a distance between two molds or mold rows in a circumferential direction.

17. A method of producing formed foodstuff, comprising:
for each of a plurality of molds on a rotary device,
determining an angular filling position of that mold on the rotary device;
determining a filling volume of that mold;
filling a predetermined portion of the filling volume of that mold via a conveying device at the angular filling position for a first filling period; and
filling a remaining portion of the filling volume of that mold via the conveying device at the angular filling position for a second filling period, the second filling period being less than the first filling period.

18. The method of claim 17, wherein determining the angular filling position includes determining a mold opening position based on a beginning of a pressure drop, and determining a mold closing position based on a beginning of a pressure rise.

19. The method of claim 17, wherein, during the first filling period, the conveying device is operated in a portion regulation mode, and wherein, during the second filling period, the conveying device is operated in a pressure regulation mode.

20. The method of claim 17, wherein the conveying device is operatively coupled to the rotary device via a supply device.

21. The method of claim 17, wherein the rotary device is one of a mold drum and a mold belt comprising at least one drive roll.
